(19) United States
(12) Patent Application Publication
(10) Pub. No.: US 2025/0377868 A1
(43) Pub. Date: Dec. 11, 2025

(54) PLATFORM FOR SUPPORTING MULTIPLE AGENTS AND APPARATUS AND METHOD FOR AUTOMATICALLY GENERATING CODE BASED ON ARTIFICIAL INTELLIGENT AGENT

(71) Applicant: Electronics and Telecommunications Research Institute, Daejeon (KR)

(72) Inventors: Sang-Cheol KIM, Daejeon (KR); Yu-Seung MA, Daejeon (KR); Hyung-Kook JUN, Seoul (KR); Sang-Yeop YEO, Daejeon (KR); Ye-Rin WOO, Daejeon (KR)

(73) Assignee: Electronics and Telecommunications Research Institute, Daejeon (KR)

(21) Appl. No.: 19/226,312

(22) Filed: Jun. 3, 2025

(30) Foreign Application Priority Data
Jun. 5, 2024 (KR) 10-2024-0073675
May 23, 2025 (KR) 10-2025-0067621

(51) Int. Cl. G06F 8/38; G06F 9/48; G06F 11/3668; G06F 16/335

(52) U.S. Cl. CPC G06F 8/38; G06F 9/4881; G06F 11/3684; G06F 16/335; G06F 2209/486

(57) ABSTRACT

Disclosed herein is an apparatus and method for automatically generating code based on artificial intelligence (AI) agents. The apparatus includes two or more agents configured to receive and convert a natural language prompt upon an event trigger, input the converted prompt into a large language model, process the output, and return the result to the user. The apparatus further includes a graphical user interface (GUI) in which functions for code generation are defined in the form of tasks. The GUI transfers event triggers to corresponding agents based on tasks selected by the user and displays the returned data. The agents are mapped to tasks and may operate in conjunction with other agents by exchanging events.

### CROSS REFERENCE TO RELATED APPLICATIONS

This application claims the benefit of Korean Patent Applications No. 10-2024-0073675, filed Jun. 5, 2024, and No. 10-2025-0067621, filed May 23, 2025, which are hereby incorporated by reference in their entireties into this application.

### BACKGROUND OF THE INVENTION

### 1. Technical Field

The disclosed embodiment belongs to the fields of software engineering, system software, and artificial intelligence technology, and particularly relates to technology for automatically generating source code by utilizing a Large Language Model (LLM).

### 2. Description of the Related Art

Currently, technology for generating code by utilizing a large language model (LLM) has considerably advanced through various publicly available LLM projects and commercial services, such as OpenAI's ChatGPT. The rapid evolution of this technology becomes a factor that promotes the use of LLMs in the area of automatic code generation, as demonstrated by innovative products such as GitHub Copilot.

Although the quality of code generation has improved with the increasing scale of language models, it is still far from perfect. This is especially because transformer models specialized for natural language processing have limitations in code understanding and generation.

Model fine-tuning, prompt tuning, ensemble techniques, data augmentation, etc. help the improvement of the performance of LLMs, but these are time-consuming and resource-intensive tasks. Therefore, training models with large-scale data and improving performance have largely been led by major corporations. However, LLM-based code generation still faces several problems as follows.

First, the quality of code generation varies depending on a coding language. For example, LLMs generate Python code well, but code generated in architecture-dependent languages, such as C or C++, by LLMs may be of lower quality.

Also, LLMs may frequently generate incorrect code and cause hallucinations by which the incorrect code can be mistaken for correct one. Particularly, as the level of difficulty of questions increases, LLMs are more likely to generate incorrect answers.

Also, when a provided prompt is not accurate, it is difficult to obtain the desired answer from LLMs, which makes it hard to control the output.

Also, there is reluctance to use commercial LLMs due to concerns over data security, especially corporate data security.

Despite the above-described problems, if it is possible to effectively manage these problems, high-quality code generation may be achieved. Ultimately, what is important is the fact that an LLM is not an all-in-one solution that can resolve all problems at once and can only produce a near-perfect final product when processed through multiple stepwise procedures.

### SUMMARY OF THE INVENTION

An object of the disclosed embodiment is to enable high-quality code that meets the user's intent to be automatically generated based on the support of agents using an LLM.

A platform with multi-agent support according to an embodiment may include a base operating system, an Artificial Intelligence (AI) operating system, an AI framework, and an agent application, the AI framework may include two or more agents for, when executed through event trigger input, receiving and converting a natural language prompt, feeding the converted prompt into a large language model, and processing and feeding back output of the large language model, and the two or more agents may be executed by being mapped to tasks of the AI operating system and may operate in conjunction with other agents by exchanging events.

Here, the agent may be executed in such a way that two or more agents are executed in parallel.

Here, the agent may include an input unit for generating a prompt in which natural language input from a user, a context previously stored in a database, and a search result generated based on a natural language prompt are reflected, a large language model processing unit for transferring the prompt to the large language model, a large language model output unit for generating an output result of the large language model, a filter and processing unit for analyzing the result and extracting information that meets requirements of the user, and a determination unit for sending a notification to the user based on the extracted information or determining whether to trigger an event to another agent.

Here, the large language model may include an internal large language model and an external large language model, and the large language model processing unit may use an authentication key to manage access to the external large language model.

Here, after it is executed through the event trigger input, the agent may generate an error when input data for the large language model is missing or when an identical event repeatedly occurs, and when no error is generated, the agent may store an inference result in a database and returns to the initial state to wait.

Here, the prompt may include at least one of role information, task information, content information required to perform a task, an output format, and policy information.

Here, the agent may include a reactive agent configured to provide a service corresponding to a predefined service list in response to a request input by a user and an autonomous agent configured to perform learning based on user input and an inference result by being automatically executed at predetermined intervals using a timer, without user input, and to provide a service.

Here, the AI framework may include an agent group in which two or more agents are connected in a directed acyclic graph structure, and each of the two or more agents included in the agent group may perform a predetermined task and then output an event to a subsequent agent connected thereto.

Here, the AI operating system may include at least one of a task that is an execution context in which an agent is executed within an operating system, a process that is a container object including two or more tasks, a scheduler for determining an execution order based on the priority of tasks, an event for activating a task, a queue for sequentially processing two or more requests to use database and large language model resources in consideration of the priority of the requests, or a virtual timer that is a software timer for periodically executing a task, or a combination thereof.

Here, the agent is an agent for program code generation, and may include at least one of a requirement definition agent for defining the objective and requirements of a system to be implemented, a design agent for generating a design method for realizing the requirements of the system, an implementation agent for generating code corresponding to designed requirements, a test agent for analyzing whether written code operates normally, a safety and security agent for analyzing functional errors or security vulnerabilities in the written code, or a documentation agent for generating a description summary document for each function for the generated code, or a combination thereof.

Here, the platform may further include a Graphical User Interface (GUI) in which functions for code generation are defined in the form of tasks, and the task may trigger an event to an agent.

An apparatus for automatically generating code based on AI agents according to an embodiment includes two or more agents for, when executed through event trigger input, receiving and converting a natural language prompt, feeding the converted prompt into a large language model, and processing and feeding back output of the large language model; and a Graphical User Interface (GUI) in which functions for code generation are defined in the form of tasks, the GUI transferring an event trigger to a corresponding agent depending on a task selected by a user and displaying data returned by the corresponding agent to the user. The two or more agents may be executed by being mapped to the tasks and may operate in conjunction with other agents by exchanging events.

Here, the agent may include an input unit for generating a prompt in which code written by the user, a context previously stored in a database, and a search result generated based on the natural language prompt are reflected, a large language model processing unit for transferring the prompt to the large language model, a large language model output unit for generating an output result of the large language model, a filter and processing unit for analyzing the generated result and extracting information that meets requirements of the user, and a determination unit for sending a notification to the user based on the extracted information or determining whether to trigger an event to another agent.

Here, after it is executed through the event trigger input, the agent may generate an error when input data for the large language model is missing or when an identical event repeatedly occurs, and when no error is generated, the agent may store an inference result in a database and return to and wait in an initial state.

Here, the agent may include a reactive agent configured to provide a service corresponding to a predefined service list in response to a request input by the user and an autonomous agent configured to perform learning based on user input and an inference result by being automatically executed at predetermined intervals using a timer, without user input, and to provide a service.

Here, the two or more agents may form an agent group in which the agents are connected in a directed acyclic graph structure to correspond to a predetermined process, and each of the two or more agents included in the agent group may perform a predetermined task and then output an event to a subsequent agent connected thereto.

Here, the agent may include at least one of a requirement definition agent for defining the objective and requirements of a system to be implemented, a design agent for generating a design method for realizing the requirements of the system, an implementation agent for generating code corresponding to designed requirements, a test agent for analyzing whether written code operates normally, a safety and security agent for analyzing functional errors or security vulnerabilities in the written code, or a documentation agent for generating a summary document for each function of the generated code.

Here, the agent may be executed in such a way that two or more agents are executed in parallel.

A method for automatically generating code based on AI agents according to an embodiment may include constructing a prompt based on code written by a user through a graphical user interface (GUI), a natural language query, and information extracted from a database, transferring an event triggered in response toa predetermined task selected by the user through the GUI to a corresponding agent, obtaining generated code from a large language model after the agent receiving the event feeds the prompt into the large language model, transferring, by the agent, a result display event to the GUI that is executing the task, and displaying, by the GUI, the code returned by the agent.

### BRIEF DESCRIPTION OF THE DRAWINGS

The above and other objects, features, and advantages of the present disclosure will be more clearly understood from the following detailed description taken in conjunction with the accompanying drawings, in which:

FIG. 1 is a schematic block diagram of a system for automatically generating code based on artificial intelligence (AI) agents according to an embodiment;

FIG. 2 is a schematic block diagram of an apparatus for automatically generating code based on AI agents according to an embodiment;

FIG. 3 is a schematic internal block diagram of a platform with multi-agent support according to an embodiment;

FIG. 4 is an internal block diagram illustrating the processing flow of an agent according to an embodiment;

FIG. 5 is an exemplary view illustrating the structure of an agent group according to an embodiment;

FIG. 6 is a flowchart for explaining the operation of an agent according to an embodiment;

FIG. 7 is an exemplary view of a prompt according to an embodiment;

FIG. 8 is a flowchart for explaining a method for automatically generating code based on AI agents according to an embodiment;

FIG. 9 is an exemplary view for comparing the similarity between a process and an agent group;

FIG. 10 is a conceptual diagram of communication between a daemon and an agent in a distributed environment according to an embodiment; and

FIG. 11 is a view illustrating a computer system configuration according to an embodiment.

### DESCRIPTION OF THE PREFERRED EMBODIMENTS

The advantages and features of the present disclosure and methods of achieving them will be apparent from the following exemplary embodiments to be described in more detail with reference to the accompanying drawings. However, it should be noted that the present disclosure is not limited to the following exemplary embodiments, and may be implemented in various forms. Accordingly, the exemplary embodiments are provided only to disclose the present disclosure and to let those skilled in the art know the category of the present disclosure, and the present disclosure is to be defined based only on the claims. The same reference numerals or the same reference designators denote the same elements throughout the specification.

It will be understood that, although the terms “first,” “second,” etc. may be used herein to describe various elements, these elements are not intended to be limited by these terms. These terms are only used to distinguish one element from another element. For example, a first element discussed below could be referred to as a second element without departing from the technical spirit of the present disclosure.

The terms used herein are for the purpose of describing particular embodiments only and are not intended to limit the present disclosure. As used herein, the singular forms are intended to include the plural forms as well, unless the context clearly indicates otherwise. It will be further understood that the terms “comprises,” “comprising,”, “includes” and/or “including,” when used herein, specify the presence of stated features, integers, steps, operations, elements, and/or components, but do not preclude the presence or addition of one or more other features, integers, steps, operations, elements, components, and/or groups thereof.

Unless differently defined, all terms used herein, including technical or scientific terms, have the same meanings as terms generally understood by those skilled in the art to which the present disclosure pertains. Terms identical to those defined in generally used dictionaries should be interpreted as having meanings identical to contextual meanings of the related art, and are not to be interpreted as having ideal or excessively formal meanings unless they are definitively defined in the present specification.

The present disclosure proposes an apparatus and method that uses AI agents to overcome the technical limitations of code generation using an LLM. That is, according to an embodiment, various agents are used to solve problems resulting from technical limitations, thereby greatly improving the quality and productivity of code generation.

To this end, an embodiment focuses on designing and building an integrated platform in which multiple AI agents operate and interact with each other. The purpose of the present disclosure is to construct an environment in which the code desired by a user can be automatically generated and to enable agents using a Large Language Model (LLM) to be efficiently executed in the code generation process. Introducing a platform that supports development provides significant advantages in utilizing various functions and roles that agents can perform in the code generation process.

Development of this platform may include the following key features for agents to consider.
Provision of a flexible code generation function for various programming languages
Minimization of hallucinations and improvement of code accuracy
Fine-grained code control and optimization based on the intent of a user
Guarantee of enhanced code security and stability
Increase in efficiency of a software development process

Meanwhile, the terms used herein will be described below first before a detailed description of an embodiment.

Language Models (LMs) refer to models that assign probabilities to sentences or words so that a computer can process natural language. These models are trained on corpora and generate sentences based on the training data. Transformer models based on attention mechanisms are being spotlighted in state-of-the-art AI-based language modeling.

Large language models (LLMs) refer to large-scale language models developed by companies such as Google, Microsoft, OpenAI, and the like based on the success of transformer-based language models. LLMs are known to produce answers with higher quality as the number of parameters increases. For example, OpenAI's GPT-3.5 and GPT-4, Google's BERT, and Meta's Llama are representative examples of LLMs. These models may also be used for special functions such as code generation. Language models specialized in code generation include Code-davinci-002, StarCoder, CodeLlama, and the like. Among large language models, relatively small language models are called small LLMs (sLLMs). In an embodiment, sLLM is regarded as a type of LLM rather than distinguishing between sLLMs and LLMs.

Large Multimodal Models (LMMs), such as Google's Gemini, OpenAI's GPT-4, and the like, are not only language models but also models in a multi-modal form, which can jointly process text and images by integrating the association between text and images.

In an embodiment, an AI-based language model is referred to as an LLM for convenience, but the present disclosure is not limited thereto. That is, Large Multimodal Models (LMMs) and small LLMs (sLLM), which are models derived from LLMs, may be treated equally with LLMs.

An agent refers to an automated system or software that acts to achieve a specific objective within a given environment. The agent has characteristics such as autonomy, goal orientation, interactivity, adaptability, and the like. The agent performs operations such as text generation, translation, and summarizing, and dynamically responds to user input.

Here, the agent may be defined as a system task that runs independently to achieve the goal desired by a user.

For example, in regard to agents for code generation, operations including Chain of Thought (CoT) or Tree of Thought (ToT), problem decomposition, objective solving (requirement definition, design, etc.), reinforcement learning via feedback (reflected reinforcement training), inference using Retrieved Augmented Generation (RAG), coding style transfer, commercial LLM cost optimization, improvement of code security and safety, virtual compilation and execution test, and error detection and bug fixing may be considered.

These types of agents may be executed by a user sequentially or in parallel.

Also, in the case of novice users who have trouble in generating code, execution of autonomous agents may be more suitable. This is because autonomous agents may actively provide feedback that the users need.

Autonomous agents should be executed in parallel, so a system for supporting the autonomous agents should provide an environment in which multiple agents can be executed in parallel. The agents should be able to easily refer to information of each other, which requires easy data communication.

Therefore, an embodiment intends to support the simultaneous execution of between 10 and 1000 agents, depending on system complexity and to enable the agents to easily exchange information.

In conclusion, an embodiment intends to build a multiple-agent system that has both precise control capabilities and cost efficiency.

A vector database is a system that is optimized to store, retrieve, and manage high-dimensional vectors. In conjunction with LLMs, the vector database plays a key role in retrieving associated information and obtaining accurate responses based on context understanding. The vector database helps LLMs perform operations based on more accurate information.

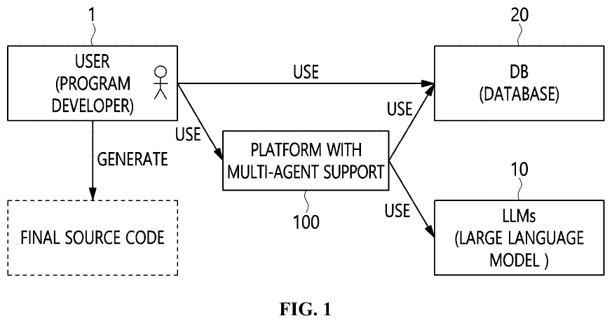

FIG. 1 is a schematic block diagram of a system for automatically generating code based on artificial intelligence (AI) agents according to an embodiment.

Referring to FIG. 1, the system for automatically generating code based on AI agents according to an embodiment is designed based on a user-centered scenario.

A program developer 1 uses a platform 100 with multi-agent support and a database 20 in order to generate final code.

The database 20 stores various kinds of information, including development intent, summaries, prompts, etc., as well as the context of the program under development.

A Large Language Model (LLM) 10 serves to generate answers to natural language input through prompt control. Here, the answers may include program code or natural language responses.

The platform 100 with multi-agent support provides an environment in which agents work.

That is, in an embodiment, the platform 100 with multi-agent support may be the core of a comprehensive architecture for integrating operation, management, and development of agents.

The agents executed in the platform 100 with multi-agent support may perform the targeted functions using the given database 20 and LLM 10.

In an embodiment, an example of generation of code based on the platform 100 with multi-agent support is described, but the platform 100 with multi-agent support may be applied not only to code generation but also to any field in which multiple agents with complex structures are required. It is expected that application of the platform 100 with multi-agent support according to an embodiment will bring about innovation across software development beyond simple code generation.

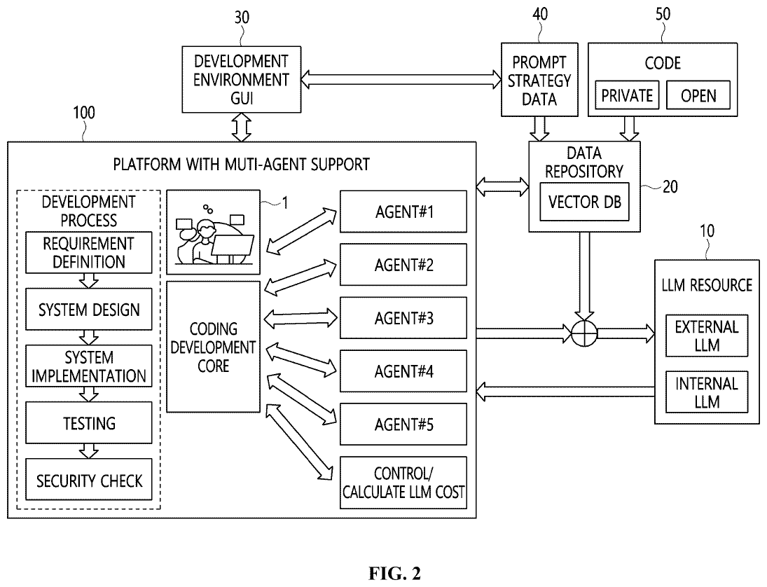

FIG. 2 is a schematic block diagram of an apparatus for automatically generating code based on AI agents according to an embodiment.

Referring to FIG. 2, the apparatus for automatically generating code based on AI agents according to an embodiment supports a process by which a user can develop complex software using an LLM 10 based on the above-described platform 100 with multi-agent support.

Here, the software development process may include requirement definition, system design, system implementation, test, and security check.

A developer 1 who performs programming develops a program through interaction between various components of the platform 100 with multi-agent support and agents and interaction between the agents and the system.

The developer 1 uses the platform 100 with multi-agent support to coordinate two or more agents to simultaneously perform operations, and both free and paid LLM resources 10 are efficiently used in this process.

A development environment GUI 30, prompt strategy data 40, and code 50, which are elements at the top, enable high-level decisions and management of the process.

The platform 100 with multi-agent support, a data repository 20, and the LLM resources 10, which are elements at the bottom, show detailed operations involved in actual code development.

In other words, interfaces with the complex system, process control components, and how the work of the developer 1 is improved through the agents using the database 20 and the LLM resources 10 are illustrated.

The data repository 20 contains prompt strategies and context data related to the code written by the developer 1, and these are used to form queries for the LLM resources 10 when an agent performs a specific operation.

However, an embodiment is not limited to using only the data repository 20 for forming an LLM query. For example, results returned by a search engine in response to developer's queries may be additionally used to form a query.

Meanwhile, the type of the LLM resources 10 may be broadly categorized into an internal LLM and an external LLM depending on the cost and whether it is managed.

Here, the internal LLM may be developed and managed in-house in order to maintain the security of the company and reduce costs. On the other hand, the external LLM is used for operations requiring high performance and involves cost based on the usage.

Here, the cost may be measured and controlled by the system. Also, the type and number of LLMs used in an embodiment are not limited.

Meanwhile, two or more agents do not necessarily have to be executed at the same time. For example, reactive agents that only respond to a request from a user may be sequentially executed, without necessarily having to be executed at the same time.

On the other hand, autonomous agents that independently think and perform operation should be run at all times, and they are often required to autonomously set goals and make decisions, in which case they should be simultaneously operated.

In order to support various types of agents, the platform 100 with multi-agent support should support parallel execution of two or more agents.

Another reason for having to support parallel execution of agents is that, when multiple resources, such as LLMs 10 or databases 20, are present, the agents that intend to use different LLMs may simultaneously perform operations. For example, when an ensemble technique, which combines results from different LLMs for a single input, is used, supporting concurrent execution contributes to reducing the time taken for an inference process.

Meanwhile, agents need the capability to interact with each other in order to perform a specific operation.

For example, when agent #1 is responsible for system design and agent #2 writes code, agent #2 should perform its operation based on what agent #2 designs. This indicates that it is necessary for the agents to share significant amounts of information therebetween. Therefore, it is necessary to design the system such that communication and data sharing between the agents are smoothly performed.

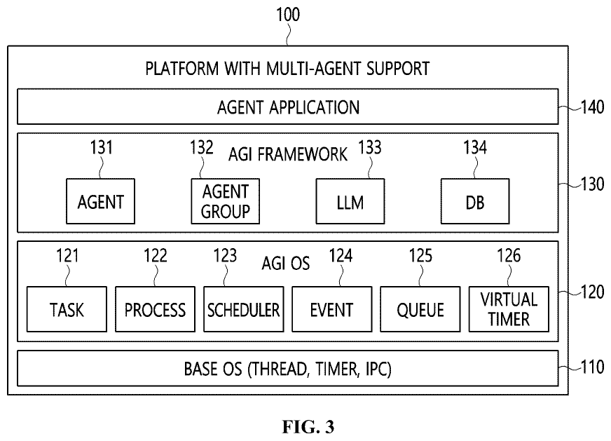

FIG. 3 is a schematic internal block diagram of a platform with multi-agent support according to an embodiment.

Referring to FIG. 3, the platform 100 with multi-agent support according to an embodiment may include four major components, which are a base Operating system (OS) 110, an Artificial General Intelligence (AGI) operating system 120, an AGI framework 130, and an agent application 140.

The base OS 110 provides the core functionality of the operating system, such as process management, software timers, inter-process communication (IPC), and the like.

Here, OSs that can be used as the base OS may include Unix-based systems, Windows-based systems, RTOS-based systems, and the like. In an embodiment, a description will be made on the assumption that the base OS 110 is Linux.

The Artificial General Intelligence Operating System (AGI OS) 120, which is a special operating system for AGI, may manage tasks 121, processes 122, task schedulers 123, events 124, queues 125, virtual timers 126, and the like based on the functionality of the base OS.

The Artificial General Intelligence (AGI) framework 130 may manage agents 131 and agent groups 132 and may also manage available LLMs 133 and databases 134.

The agents 131 and the agent groups 132 are executed by being mapped to the tasks 121 of the AGI OS 120 and may operate in conjunction with other agents or agent groups by exchanging events.

As the agent application 140, an agent-related application developed using objects within the AGI framework 130 is executed. With the support of the AGI framework 130 and the AGI OS 120, an environment in which multiple agents can be executed in parallel is provided.

The above-described platform 100 with multi-agent support may efficiently handle complex operations, and each agent performing a specific operation extends the functionality of the entire system.

Hereinafter, the internal components of the platform 100 with multi-agent support illustrated in FIG. 3 will be described in detail.

### 1. AGI Framework (130)

### 1.1 Agent (131)

### (1) Characteristics of Agent

An agent refers to an automated system or software that acts to achieve a specific objective within a given environment. Such an agent has the following characteristics:
Autonomy: an agent has the capability to make decisions on its own to achieve a given goal. For example, the agent performs operations such as text generation, translation, summarizing, etc., and dynamically responds to input from a user.
Goal-oriented: an agent operates for a specific goal. In LLMs, the goal may take the form of understanding, generating, or transforming text.
Interactivity: an agent may collect information, react, and adjust actions for achieving a goal through interaction with a user or other systems.
Adaptability: an AI agent using an LLM may improve performance and adapt to a new environment or requirements through training. This is achieved based on the knowledge that a model acquires from training data.

### (2) Basic Processing Flow of Agent

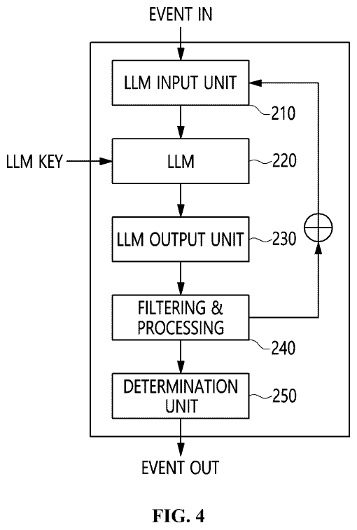

FIG. 4 is an internal block diagram illustrating the processing flow of an agent according to the embodiment.

Referring to FIG. 4, when it is executed through event trigger input, the agent 131 may process sequential steps for receiving and converting a natural language prompt, feeding the converted prompt into a large language model, processing the output of the large language model, and finally providing feedback to a user.

An LLM input unit 210 may generate a prompt in which a context previously stored in the database and a search result generated based on a natural language prompt are reflected to the natural language input from the user.

That is, the natural language prompt input from the user, the context, the search result, and the like are converted into the input of the LLM. If the agent has the context stored in a file or DB, the context is reflected in the input, whereby the agent is adapted to the environment. This is referred to as in-context learning, which is related to prompt tuning. Also, if there is any search result generated based on a natural language prompt, the search result is reflected in the input.

An LLM processing unit 220 processes the input of the prompt into the large language model. That is, the LLM processing unit 220 processes the input through the set LLM, and when the user is a paid user using an external LLM, the LLM processing unit 220 uses an authentication key to manage access to the LLM.

An LLM output unit 230 generates output based on the processing result of the LLM, and the output may be code, text, or other data formats.

A filter and processing unit 240 analyzes the generated output, thereby extracting information that meets the requirements of the user. Here, if the processed information is needed later, it is separately stored by including it in the context. Here, the generated information may be reused by the LLM input unit 210.

A determination unit 250 sends a notification to the user based on the extracted information or generates an additional event according to need.

The agent 131 is executed by an event trigger (event IN), and upon completion of the execution, the agent 131 generates and outputs an event (event OUT) to notify other agents or systems.

### (3) Type of Agent

AI agents may be broadly classified into reactive (passive) agents and autonomous (active) agents.

Here, a reactive agent has often been trained in advance and provides service only in response to a request input by a user.

An autonomous agent is an agent that constantly learns and strives to help a user on its own, without user intervention.

As described above, autonomous agents have more advanced agent functions and are more difficult to design. However, it is difficult to see that reactive agents have worse performance than autonomous agents. When a reactive agent has already been trained well with sufficient data, it may have much better performance than expected.

The reactive agent may function to provide a service required to achieve a specific goal. The agent designed in the form of a service provider has a predefined service list, and when an external request is input, the agent executes a corresponding service function, provides a resultant service to the requester, and then waits in the initial state again.

Here, the agent not only processes the event input but also may identify a request through a unique number for identifying the service request and process the same.

The autonomous agent has the characteristic of evolving itself to achieve a goal. The agent has a function by which it is periodically executed, and it aims to better understand the intent of a user and improve the quality of inference by performing learning based on the input from the user and inference results. When the user does not have expertise, this kind of agent may be of great help by gradually gaining expertise through the inference process.

### (4) Evolution of Agent

Generally, AI agents may be designed to have more advanced intelligence. An LLM is a pretrained large language model, and agents perform additional fine-tuning using an LLM in order to achieve a specific goal.

A prompt, which corresponds to the input of an LLM, may have content that is dynamically changed depending on the situation (environment) to enable learning according to the context. For example, when the LLM input containing a question or the intent of a user includes a consecutive set of questions over time ((question 1, answer 1), (question 2, answer 2), . . . ), the final output of the LLM provides a result in which all of these inputs are taken into account. In other words, this indicates that the agent reflects the intent of a user and gradually evolves to achieve a specific goal.

When discussing the evolution of an agent, reinforcement learning is often mentioned. This is the process in which, when an agent takes a certain action, the agent learns the policy (plan) of the action through a reward or penalty depending on how well the result of the action meets a goal (i.e., the final intent of the user). In the field of automatic code generation, a reward is given when the user accepts the suggestion of the agent (e.g., generated code), and a penalty may be imposed when the user does not accept it. Only when this procedure transparently proceeds without the direct participation of users may the system be considered a good training system.

### 1.2 Agent Group (132)

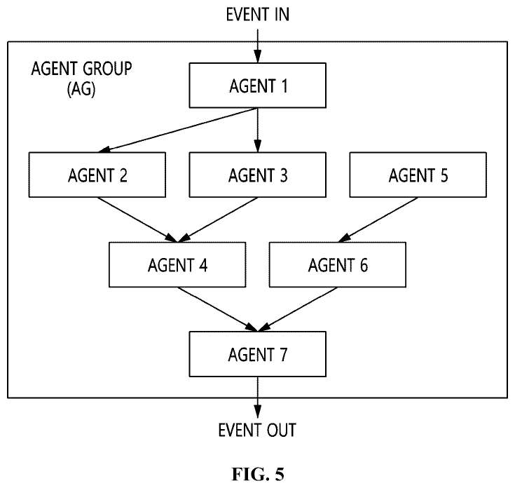

FIG. 5 is an exemplary view illustrating the structure of an agent group according to an embodiment.

Referring to FIG. 5, the relationship between agents in an agent group is systematically represented through a Directed Acyclic Graph (DAG) structure, and the agent group is designed to divide and distribute complex agent operations.

This structure is intended to allow each agent to achieve a specific subgoal in order to achieve the overall goal.

In the agent group, the dependencies between agents are explicitly defined by a designer, and the agents operate unidirectionally within the predefined order of the DAG.

That is, each of the two or more agents included in the agent group performs a predetermined task and then outputs an event to the subsequent agent connected thereto.

This structure is extended to a hierarchical form, thereby facilitating achievement of integrated goals, beyond the individual functions of the agents. For example, the agent group may be used to implement complex processing scenarios such as Chain of Thought (CoT) or Tree of Thought (ToT).

For example, referring to FIG. 5, a total of seven agents are connected to each other, and each of the agents performs a specific task and then transfers an operation to the subsequent agent. Finally, after the operations of all of the agents are completed, the last agent (agent 7) is executed and obtains the final result. This drawing focuses on helping developers design and understand the workflow between agents.

### 1.3 LLM (133) and DB (134)

Large language models (LLMs) and databases (DBs) have unique characteristics depending on the vendors, so it is essential to abstractly represent the characteristics within a platform such that a unified interface is provided.

### (1) LLM Considerations

Natural language input: this includes a prompt in which a query of a user is provided in the form of natural language.
API key: when a paid LLM service is used, an authentication key is required for API calls.
Vendor and versions: this specifies the vendor and software version information of the LLM in use.
LLM filtering function: a filtering function that is applied to process a response from the LLM to meet the purpose is provided.
Cost: when an external LLM is used for a fee, cost is incurred and managed.

When multiple agents simultaneously make inference requests to the same LLM, the requests are sequentially processed through an LLM wait queue to prevent conflicts. This prevents resource contention caused by concurrent LLM requests, thereby ensuring the stability of the system.

### (2) Database

Databases have various usage methods depending on the vendor and provide basic APIs for storage of training data, queries, and extraction functions. For example, Pinecone is a representative vector DB solution used along with LLMs, and each DB vendor provides its own APIs.

For code generation, the database may store the following content.

First, the database stores agent-related code, documents, and summaries. An agent may generate code or give advice on the current code based on the documents stored in the DB. In particular, when Retrieval Augmented Generation (RAG) technology for reducing hallucinations is used, the content stored in the DB serves as the basis for the advice.

Also, the database stores the result of inference performed by an agent in the form of context. The context of the agent is frequently stored in the database, and the stored context may be used for queries to help training of the agent or may be used by the agent to prepare for unexpected failures (computer power failure, etc.). For reference, the context does not necessarily have to be stored in the DB, and may alternatively be saved in a file format.

### 1.4 How Agent Works

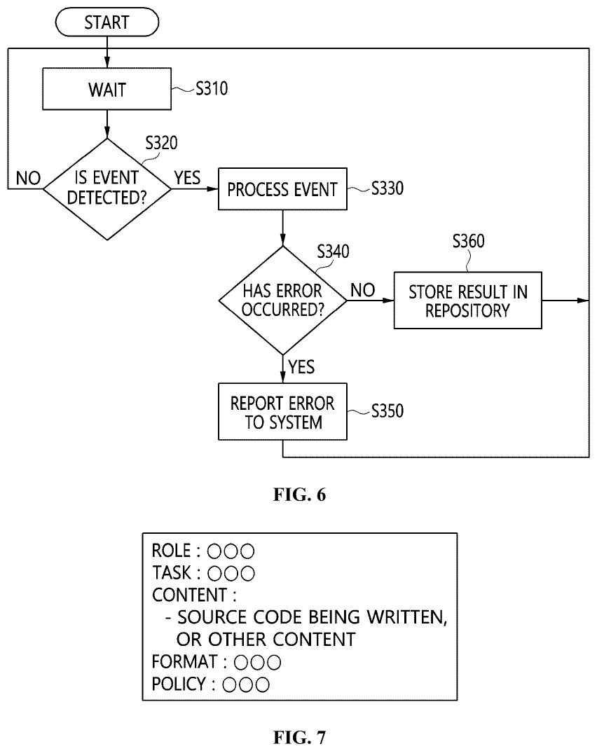

FIG. 6 is a flowchart for explaining the operation of an agent according to an embodiment.

Referring to FIG. 6, a generated agent is registered in the operating system, and when the system is started, the agent is activated and waits for an event at step S310.

The agent is executed when a specific event triggered from outside the agent is detected at step S320.

The agent is mapped to a task on the operating system, and the task is mapped to a thread on the base operating system and is executed at step S330.

The agent is executed through event trigger input, and it may generate an error at step S340 depending on whether the input data into the large language model is missing or whether the same event is repeated.

In other words, input data is essential to run the LLM. When an event occurs in the agent but the input data of the LLM is missing, which causes an error at the time of executing the agent. Also, when the same events concurrently occur multiple times, the repeated events are ignored, and an error is reported at step S350.

When no errors occur, an inference result is stored in the repository such as a DB at step S360, and the agent waits in the initial state at step S310.

Autonomous agents need to be periodically executed for learning and evolution, so each agent may have its own timer. The timer triggers an event at set intervals to drive the agent to periodically perform a specific operation.

### 2. Agent Application

FIG. 7 is an exemplary view of a prompt according to an embodiment.

Referring to FIG. 7, the prompt may include at least one of role information, task information, content information required to perform a task, an output format, or policy information, or a combination thereof.
Role: the basic role of an agent is specified.
Task: a specific operation instruction that the agent has to complete is defined here.
Content: information required to perform a task or the code being written is included.
Format: a data format in which the agent should produce a processing result is specified. For example, JSON or Python file extension may be specified.
Policy: rules, examples, or constraints that should be taken into consideration in performing a task are described here.

This configuration provides guidelines required for an agent to accurately and efficiently process an operation assigned thereto. However, the prompt illustrated in FIG. 7 is merely an example for explaining the present disclosure, and the present disclosure is not limited thereto. That is, the input prompt may have any of various forms.

The format of an output may be represented using a file extension such that the agent is able to convert the result output from the LLM into the specified format. For reference, ‘OOO’ in FIG. 7 indicates a blank that should be filled with a sentence.

### 2.1 Configuration of Prompt for Code Generation

Prompt settings may be very flexibly adjusted. The example of the prompt in FIG. 7 shows that a task, an output format, and a rule form a basic framework, but content may change depending on the specific function of the agent.

Particularly, there are no limitations or restrictions on the format of content (a file, text, a web address, etc.), and the content may be acquired from various sources, such as the code being written by a user, information retrieved from the database, Internet search results, the context of results, and the like. Also, information acquired by combining, analyzing, filtering, or summarizing documents acquired from various search results may be used as a part of the content.

The configuration of the prompt has a decisive influence on the evolution of the agent. When there is a large number of agents with a specific goal, the configuration and content of the agents may be referred to so that the prompt is dynamically configured. This allows all the agents to be organically connected and evolve like living organisms when code is generated.

### 2.2 Examples of Basic Agents for Code Generation

An embodiment includes a system configured with multiple intelligent agents that support software development and maintenance work. These agents may contribute to writing and maintaining high-quality code and have capabilities to significantly increase the programming productivity.

Various types of agents that specialize in code generation are available, but only a few examples are illustrated. The names of the agents mentioned are arbitrarily set for illustrative purposes only, and the scope of the functions that the agents can perform may extend beyond those mentioned here. In the present disclosure, at least 10 and up to 1000 agents are assumed.

Table 1 is an exemplary list of basic agents for code generation according to an embodiment.

TABLE 1

| Category | Type of basic agent |
|---|---|
| Requirement | (Requirement agent) This agent defines the objective of the system to |
| definition | implement and presents requirements for the objective. It generates |
| | user requirements and system requirements separately. |
| Design | (SysDesign agent) This agent generates a design method for realizing |
| | system requirements. It describes the function, scope, and limitation |
| | of each design module. |
| Implementation | (CodeGeneration agent) This agent generates code corresponding to |
| | natural language input. |
| | (CodeFilling agent) This agent automatically fills the rest of code to |
| | meet the objective of the entire function. |
| | (Refine agent) This agent revises a code style, recommends function |
| | and variable names, and provides recommendations based on coding |
| | guidelines such as ISO international standards. |
| Test | (TestSet generation and execution agent) This agent generates test |
| | cases for determining whether the written code operates correctly and |
| | checks whether the code passes the tests. |
| Safety and | (BugFix agent) This agent detects functional errors such as memory |
| Security | leaks, compilation errors, runtime errors, and the like. A logic error |
| | detection function checks whether the direction of code writing |
| | matches the objective thereof. |
| | (Security agent) This agent detects security vulnerabilities in the |
| | written code and suggests a solution. |
| Documentation | (Document agent) This agent automatically generates a description |
| | summary document for each function of the generated code and |
| | automatically summarizes a description of the entire development |
| | process. |

### 2.3 Development Environment GUI (30)

In a development environment, a code generation operation is typically performed through a graphical user interface (GUI) 30 as illustrated in FIG. 2. Various functions of the GUI are defined in the form of tasks, and each task may generate an event for transferring information to an agent.

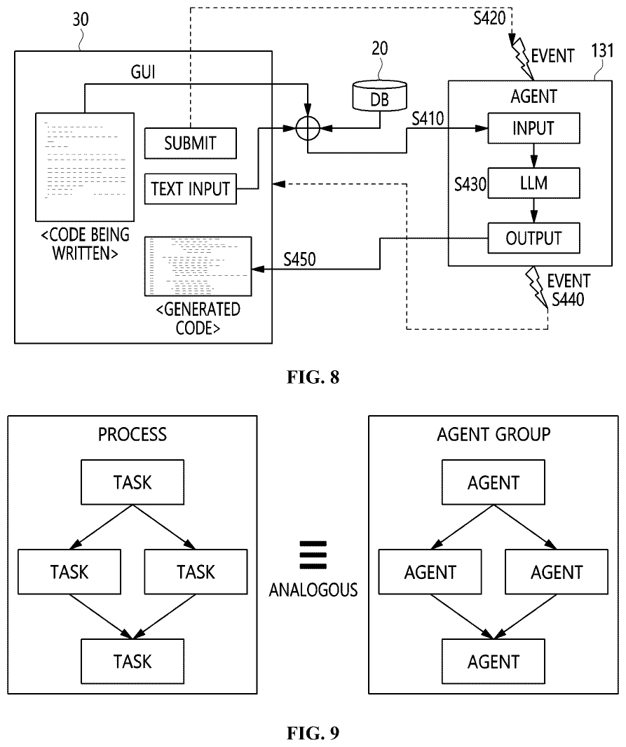

FIG. 8 is a flowchart for explaining a method for automatically generating code based on AI agents according to an embodiment.

Referring to FIG. 8, an example of the interaction between the GUI 30 and a reactive agent 131 is illustrated.

The method for automatically generating code based on AI agents according to an embodiment may include constructing a prompt based on code written by a user through the GUI, a natural language query, and information extracted from a database at step S410, transferring an event triggered depending on a predetermined task selected by the user through the GUI to a corresponding agent at step S420, feeding, by the agent receiving the event, the prompt into a large language model and obtaining the generated code from the large language model at step S430, transferring, by the agent, a result display event to the GUI that is executing the task at step S440, and displaying, by the GUI, the code returned by the agent at step S450.

That is, the prompt input is generated at step S410 before execution of the agent. The prompt input may include a combination of the code written by a developer, a natural language query, and information extracted from the database 20.

At step S420, an event is triggered through a specific operation in the GUI 30, e.g., clicking on the ‘Submit’ button, or the like, and is then transferred to the relevant agent 131.

At step S430, the agent receiving the event submits the input to the LLM and obtains the result.

At step S440, the agent 131 transfers an event to announce the preparation of the result to the GUI 30 that is executing the task.

At step S450, the GUI 30 receives the output returned by the agent 131 and displays the output to the user or uses the same for other purposes.

Here, the key is seamless communication between the GUI and the agent, along with event-based interaction, which allows the developer to effectively work and quickly receive a result. All data flows and interaction occurring in this process are represented in the drawing, and this representation is very important to understand how the development environment operates.

The purpose of presenting an example of a development environment GUI is to show that a system may include not only agents but also other GUI-related tasks that perform specific operations in conjunction with the agents.

### 3. AGI Operating System (120)

In an embodiment, the system should provide the capability to simultaneously execute multiple agents, and the agents should be allowed to simultaneously access any of various types of LLMs. In order to efficiently coordinate such a complex workflow, an operating system for integrated management of resources, including agents, LLMs, and databases (DBs), is essential.

### 3.1 Task (121)

A task refers to the execution context in which an agent is executed within the operating system. Agents are assigned to tasks of the operating system, and the order of processing LLM requests is determined depending on the priority of the tasks. In response to execution requests, an agent with high priority is privileged to be executed before an agent with low priority. It may be noted that an agent is executed based on an event or is periodically executed based on a timer.

Although agents are commonly executed as tasks, other types of tasks may also be executed independently of the agents within the operating system. For example, an exception-handling task for responding to urgent situations and an idle task for managing the system in the idle state are present. In addition, there is a monitoring task for checking the state of the system. These tasks have roles and priorities different from those of the agents and work according to various requirements of the system. That is, it is important to understand that the agent-based tasks and other tasks may work together within the system.

Also, tasks required for the GUI-based development environment illustrated in FIG. 8 are present, and these tasks react when a developer edits, builds, and debugs code.

### 3.2 Process (122)

A process may be seen as a container object including tasks. Execution of a process means sequentially executing multiple tasks included therein.

As individual agents are mapped to specific tasks, an agent group is mapped to a single process.

FIG. 9 is an exemplary view for comparing the similarity between a process and an agent group.

Referring to FIG. 9, agents belonging to an agent group function as individual tasks, and the tasks are executed within a process. The interaction structure of the agents in the agent group directly corresponds to the connection of the tasks within the process. The structure and mapping are important factors in understanding the workflow of the system.

### 3.3 Scheduler (123)

A scheduler is an essential component for managing tasks in the operating system. When there is a large number of tasks and management thereof is complex, the scheduler plays a key role. The task scheduler first determines the order of execution based on the priority of each task. Tasks with the same priority are processed in a First-In First-Out (FIFO) manner in the order of arrival at a waiting queue.

### 3.4 Event (124)

Tasks in the operating system are executed based on events, and an event generated by a task or timer activates another task in a standby state. The task that receives the event is switched from the standby state to the active state, and the associated agent processes LLM input in response to the corresponding event and starts a following operation.

### 3.5 Queue (125)

A queue is a fundamental computer data structure for managing the order of tasks and resource requests and is mainly used to process multiple requests to use LLM and DB resources sequentially or in consideration of the priority. When multiple requests are waiting, a synchronization tool, such as a semaphore or a mutex, is used to execute tasks in the order of arrival, thereby preventing conflicts.

### 3.6 Virtual Timer (126)

A timer may be used for periodically executing a task, and multiple virtual timers may be generated. The virtual timers have the advantage of supporting a greater number of software timers than hardware timers based on the hardware timers provided by the system. However, the virtual timers are software timers, so they have lower precision than the hardware timers.

### 3.7 Startup of the Operating System

When the operating system starts, first, the idle task with the lowest priority is activated. Then, the agent tasks registered in the system prepare for execution and enter a standby state in which they wait for an event to arrive. When an event arrives, agent tasks that respond to the corresponding event start actions. These agent tasks have higher priority than the idle task, and they may be executed according to need. When the operation of the agent finishes, the agent goes back to the standby state and waits for a new event.

When all agent tasks are in a standby state and when no other tasks are working, the system executes the idle task again. The idle task does nothing in practice and spends most of the time in sleep mode (power-saving mode), thereby reducing the energy consumption of the system.

This description relates to how the operating system works in a single system, and the above-described operation method is identical or similar to the operation method of a real-time operating system (RTOS).

### 3.8 Operation of Operating System in Distributed Environment

### (1) Configuration of Distributed System

In regard to a platform on which agents are executed, the basic unit on which the platform is constructed and operated is called a ‘node’. Nodes may be run together on the hardware of a single server or may be run on the hardware of different servers by being distributed.

Each node also has a daemon task that enables communication between nodes. The daemon task is categorized into a server daemon and a client daemon depending on the function. Each node executes not only the daemon task but also the platform with multi-agent support, which includes the AGI operating system.

When all nodes are run on the hardware of a single server, the nodes may be run separately using a virtualization technique called container.

### (2) Network Configuration Between Daemon Tasks

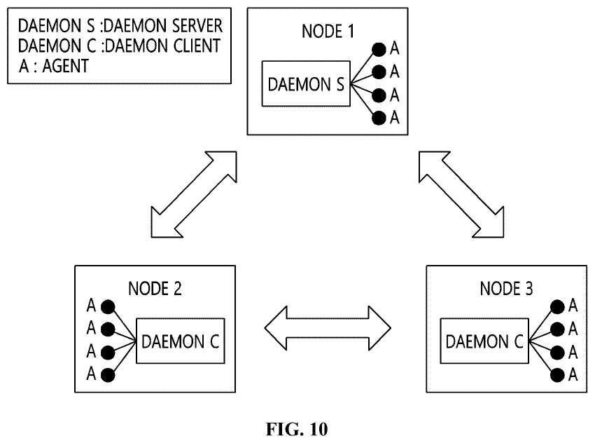

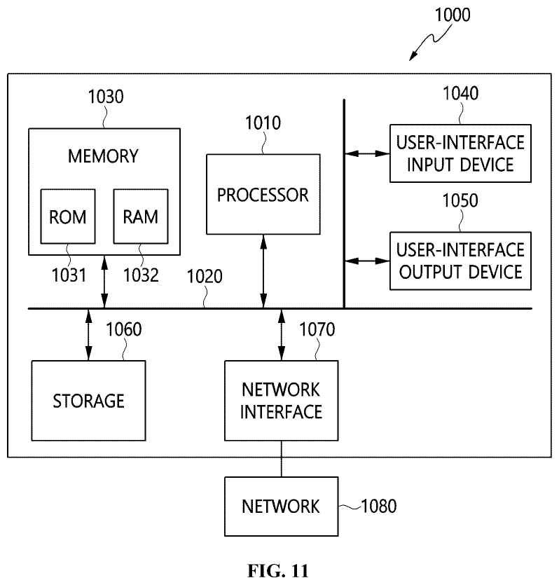

When daemon tasks are first executed, they are connected to each other. Client daemon tasks are connected to a server daemon task in a N:1 relationship. As shown in FIG. 10, all agents have been registered in the daemon task of the node to which the agents belong. The server daemon task manages all client daemon tasks connected thereto and a list of agents that the client daemon tasks have. Accordingly, specific nodes may learn about agents working on other nodes.

### (3) Communication Between Agents in Distributed Environment

A daemon task in a node maintains a list of agents working on the node. Based thereon, an event from another node may be delivered to an agent in the corresponding node or an event occurring in the corresponding node may be sent to another node. The daemon task serves to relay agents between nodes such that they communicate with each other.

### (4) Communication Between Daemon Task and Agent

Agents exchange events with a daemon task.

FIG. 10 is a conceptual diagram illustrating communication between a daemon and an agent in a distributed environment according to an embodiment.

The communication between the agent and the daemon task illustrated in FIG. 10 is based on Inter-Process Communication (IPC). However, the form of communication may be socket communication depending on the execution form of the task that executes the agent (e.g., a thread, a process, a container, etc.).

### 3.9 Configuration of Communication Hardware Between Nodes

It should be possible for tasks to exchange information through event triggers. In the present disclosure, it is assumed that socket communication is used by default for communication between nodes. Socket communication enables reliable communication between nodes. When multiple disturbed nodes are connected to an Ethernet or Wi-Fi communication device, socket communication is possible.

### 4. Base Operating System (110)

The AGI operating system is built based on the base operating system and utilizes the multi-task processing capabilities of the base operating system. This indicates that there is no need to specially consider additional techniques such as task context switching. For example, a variety of necessary functions and technologies are already integrated in the base operating system, such as Linux, so the base operating system is a good starting point for developing an AGI operating system. The base operating system provides the following related technologies.
Multi-threading/multi-process technology provides the capability to execute multiple tasks simultaneously.
IPC technology (message queue, shared memory, etc.) and synchronization mechanisms (semaphore and mutex) are supported.
Development tools for various programming languages, such as C, C++, Python, etc., are included.
GPU acceleration libraries for supporting various programming languages and running LLMs are supported.
Container technology for virtualizing an operating system is provided. Multiple processes are virtually isolated at the OS level to provide separate services without affecting each other.

In an embodiment, tasks are assumed to be mapped to threads on the base operating system (e.g., Linux). However, the tasks may alternatively be mapped to processes or containers supported by the base operating system. In this case, it is difficult to directly share memory data between the tasks, which may lead to a lot of data communication load. Also, an event is mapped to a communication message of the base operating system. In order to receive communication messages, threads, processes, or containers may run message queues or socket communication servers in the base operating system.

### <Example of Agent Control Task API>

After completing the development of an agent, an agent developer may want to verify whether the agent operates normally. In order to control the agent, a separate task is required to be ready for verification in an application, and the verification task prepares input for operating the agent and then triggers an input event to the agent, thereby verifying execution of the agent. While the agent is running an LLM, the verification task waits for an output event, and upon arrival of the output event from the agent, the task may receive the result of the execution of the agent.

Depending on the circumstances, the verification task may be set not to wait for the output event from the agent. In this case, the verification task is executed without waiting, and even though an output event occurs, the output event is ignored.

Examples of APIs of a verification task for controlling an agent under the above-described conditions are listed below. Using these basic APIs, it is possible to properly control an agent or verify execution thereof.
Agent_send_event (agent ID, input): This API sends an input event to an agent. The argument ‘input’ indicates the memory space (or file) in which input text is located.
Agent_get_event (output): This API waits for occurrence of an output event of an agent. When an output event occurs, the standby state is switched to an execution state and the output text (or file) is stored in ‘output’.
Agent_test_output_event (output): This API tests whether an output event of an agent occurs. When the output event occurs, this API returns True and stores the output of the agent in ‘output’, otherwise, it returns False.
Agent_info (agent ID, info): This API acquires the state information of the agent. How to use the agent (operating method), memory space in use, and the like may be monitored.

According to the embodiment described above, code generation quality may be improved based on agents using a Large Language Model (LLM).

The embodiment includes a platform with artificial general intelligence (AGI) capabilities for code generation to support the execution of multiple agents with various functions.

Here, the effect of using the embodiment may vary depending on the design and configuration of an agent. However, the following common effects may be expected to be obtained by using the system proposed in the present disclosure in the automatic code generation field.
High-quality code generation: code generation in which the intent of a user is more accurately reflected is supported.
Stable code generation: code accuracy and reliability may be improved by reducing hallucinations and errors.
Secure code generation: secure use in corporate environments may be ensured through enhanced data security.
Improved development efficiency relative to cost: cost may be reduced by reducing development time and increasing efficiency by providing a usage method in the form of a platform.

The present disclosure facilitates innovation in a software development process using artificial general intelligence and enables developers to generate and optimize high-quality code more efficiently in the field of automatic code generation.

FIG. 11 is a view illustrating a computer system configuration according to an embodiment.

At least one of the apparatus for automatically generating code based on AI agents, or the platform with multi-agent support, or a combination thereof according to an embodiment may be implemented in a computer system 1000 including a computer-readable recording medium.

The computer system 1000 may include one or more processors 1010, memory 1030, a user-interface input device 1040, a user-interface output device 1050, and storage 1060, which communicate with each other via a bus 1020. Also, the computer system 1000 may further include a network interface 1070 connected with a network 1080. The processor 1010 may be a central processing unit or a semiconductor device for executing a program or processing instructions stored in the memory 1030 or the storage 1060. The memory 1030 and the storage 1060 may be storage media including at least one of a volatile medium, a nonvolatile medium, a detachable medium, a non-detachable medium, a communication medium, or an information delivery medium, or a combination thereof. For example, the memory 1030 may include ROM 1031 or RAM 1032.

According to the disclosed embodiment, high-quality code that meets the intent of a user may be automatically generated based on the support of agents using an LLM.

Although embodiments of the present disclosure have been described with reference to the accompanying drawings, those skilled in the art will appreciate that the present disclosure may be practiced in other specific forms without changing the technical spirit or essential features of the present disclosure. Therefore, the embodiments described above are illustrative in all aspects and should not be understood as limiting the present disclosure.

What is claimed is:

1. A platform with multi-agent support, comprising:
a base operating system, an Artificial Intelligence (AI) operating system, an AI framework, and an agent application,
wherein:
the AI framework includes two or more agents for, when executed through event trigger input, receiving and converting a natural language prompt, feeding the converted prompt into a large language model, and processing and feeding back output of the large language model, and
the two or more agents are executed by being mapped to tasks of the AI operating system and operate in conjunction with other agents by exchanging events.

2. The platform of claim 1, wherein the agent is executed in such a way that two or more agents are executed in parallel.

3. The platform of claim 1, wherein the agent includes
an input unit for generating a prompt in which natural language input from a user, a context previously stored in a database, and a search result generated based on a natural language prompt are reflected;
a large language model processing unit for transferring the prompt to the large language model;
a large language model output unit for generating an output result of the large language model;
a filter and processing unit for analyzing the result and extracting information that meets requirements of the user; and
a determination unit for sending a notification to the user based on the extracted information or determining whether to trigger an event to another agent.

4. The platform of claim 3, wherein
the large language model includes an internal large language model and an external large language model, and
the large language model processing unit uses an authentication key to manage access to the external large language model.

5. The platform of claim 1, wherein
after being executed through the event trigger input, the agent generates an error when input data for the large language model is missing or when an identical event repeatedly occurs, and
when no error is generated, the agent stores an inference result in a database and returns to the initial state to wait.

6. The platform of claim 1, wherein the prompt includes at least one of role information, task information, content information required to perform a task, an output format, and policy information.

7. The platform of claim 1, wherein the agent includes
a reactive agent configured to provide a service corresponding to a predefined service list in response to a request input by a user; and
an autonomous agent configured to perform learning based on user input and an inference result by being automatically executed at predetermined intervals using a timer, without user input, and to provide a service.

8. The platform of claim 1, wherein
the AI framework includes an agent group in which two or more agents are connected in a directed acyclic graph structure, and
each of the two or more agents included in the agent group performs a predetermined task and then outputs an event to a subsequent agent connected thereto.

9. The platform of claim 1, wherein the AI operating system includes at least one of
a task that is an execution context in which an agent is executed within an operating system;
a process that is a container object including two or more tasks;
a scheduler for determining an execution order based on priority of tasks;
an event for activating a task;
a queue for sequentially processing two or more requests to use database and large language model resources in consideration of priority of the requests; or
a virtual timer that is a software timer for periodically executing a task;
or a combination thereof.

10. The platform of claim 1, wherein the agent is an agent for program code generation and includes at least one of a requirement definition agent for defining an objective and requirements of a system to be implemented, a design agent for generating a design method for realizing the requirements of the system, an implementation agent for generating code corresponding to designed requirements, a test agent for analyzing whether written code operates normally, a safety and security agent for analyzing functional errors or security vulnerabilities in the written code, or a documentation agent for generating a description summary document for each function for the generated code, or a combination thereof.

11. The platform of claim 1, further comprising:
a Graphical User Interface (GUI) in which functions for code generation are defined in a form of tasks,
wherein the task triggers an event to the agent.

12. An apparatus for automatically generating code based on artificial intelligence (AI) agents, comprising:
two or more agents for, when executed through event trigger input, receiving and converting a natural language prompt, feeding the converted prompt into a large language model, and processing and feeding back output of the large language model; and
a Graphical User Interface (GUI) in which functions for code generation are defined in a form of tasks, the GUI transferring an event trigger to a corresponding agent depending on a task selected by a user and displaying data returned by the corresponding agent to the user,
wherein the two or more agents are executed by being mapped to tasks and operate in conjunction with other agents by exchanging events.

13. The apparatus of claim 12, wherein the agent includes
an input unit for generating a prompt in which code written by the user, a context previously stored in a database, and a search result generated based on the natural language prompt are reflected;
a large language model processing unit for transferring the prompt to the large language model;
a large language model output unit for generating an output result of the large language model;
a filter and processing unit for analyzing the generated result and extracting information that meets requirements of the user; and
a determination unit for sending a notification to the user based on the extracted information or determining whether to trigger an event to another agent.

14. The apparatus of claim 12, wherein
after being executed through the event trigger input, the agent generates an error when input data for the large language model is missing or when an identical event repeatedly occurs, and
when no error is generated, the agent stores an inference result in a database and returns to and waits in an initial state.

15. The apparatus of claim 12, wherein the agent includes
a reactive agent configured to provide a service corresponding to a predefined service list in response to a request input by the user; and
an autonomous agent configured to perform learning based on user input and an inference result by being automatically executed at predetermined intervals using a timer, without user input, and to provide a service.

16. The apparatus of claim 12, wherein
the two or more agents form an agent group in which the agents are connected in a directed acyclic graph structure to correspond to a predetermined process, and
each of the two or more agents included in the agent group performs a predetermined task and then outputs an event to a subsequent agent connected thereto.

17. The apparatus of claim 16, wherein the agent includes at least one of
a requirement definition agent for defining an objective and requirements of a system to be implemented;
a design agent for generating a design method for realizing the requirements of the system;
an implementation agent for generating code corresponding to designed requirements;
a test agent for analyzing whether written code operates normally;
a safety and security agent for analyzing functional errors or security vulnerabilities in the written code; or
a documentation agent for generating a summary document for each function of the generated code.

18. The apparatus of claim 17, wherein the agent is executed in such a way that two or more agents are executed in parallel.

19. A method for automatically generating code based on artificial intelligence (AI) agents, comprising:
constructing a prompt based on code written by a user through a graphical user interface (GUI), a natural language query, and information extracted from a database;
transferring an event triggered in response to a predetermined task selected by the user through the GUI to a corresponding agent;
obtaining generated code from a large language model after the agent receiving the event feeds the prompt into the large language model;
transferring, by the agent, a result display event to the GUI that is executing the task; and
displaying, by the GUI, the code returned by the agent.
